(19) United States
(12) Patent Application Publication
(10) Pub. No.: US 2008/0236251 A1
(43) Pub. Date: Oct. 2, 2008

(54) Chemical Sensing Apparatuses, Methods and Systems

(76) Inventors: Gary C. Tepper, Glen Allen, VA (US); Royal Kessick, Richmond, VA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 11/692,915

(22) Filed: Mar. 28, 2007

(51) Int. Cl. G01N 27/04; B01J 19/00

(52) U.S. Cl. 73/31.05; 422/82.02

(57) ABSTRACT

A microchip based sensor for detecting at least one analyte which includes at least one microelectrode for measuring the electrical resistance of the at least one analyte, and an array of electrospun composite fibers interfaced with at least one of the microelectrodes. The one or more analytes are identified from the resistance pattern of the one or more analytes. Other embodiments can be used to identify and/or quantify one or more of the analytes from the resistance pattern of those one or more analytes.

### CROSS-REFERENCES TO OTHER RELATED PATENT APPLICATIONS

This application claims the benefit of U.S. provisional application Ser. No. 60/092,707, filed Mar. 28, 2006 which is incorporated by reference in which is incorporated herein by reference in its entirety for all purposes.

### STATEMENT REGARDING FEDERALLY SPONSORED RESEARCH OR DEVELOPMENT

The research carried out in this application was supported in part by a grant from the United States Air force Office of Scientific Research (#FA9550-04-C-0007). The U.S. government may have rights in any patent issuing from this application.

### REFERENCE TO SEQUENCE LISTING, A TABLE, OR A COMPUTER PROGRAM LISTING COMPACT DISK APPENDIX

None.

### BACKGROUND

The field of the claimed subject matter relates to sensor arrays and techniques for the detection of analytes.

There are devices and instruments which are known in the art that are used for general detection of analytes in a fluid, vacuum, air, or other medium. One type of analyte detector is a device for sensing smell or odors found in the air. Other devices for the general detection of analytes can be used for the detection of chemical leaks, quality control in food processing, medical diagnostics and testing, fabrication of prototypes as well as the manufacture of commercial and industrial goods, pharmaceutical development and production, testing or evaluating an analyte in any medium, for instance air, gas composition, fuel, oil, wine, water or other suitable solvents), and for many other possible applications.

Some of the prior art references incorporate the use of a plurality of sensors to sense or detect analytes. One technology that may be used is integrated circuit or solid state technology. Some embodiments of the claimed subject matter may be manufactured using solid state/integrated circuit technology. However, other embodiments are not limited to implementations using solid state technology as other technologies may also be used.

For example, both U.S. Pat. No. 7,061,061 and U.S. Patent Application No. US2006/0208254 to Goodman, et al. describe various techniques and devices which can be used to detect and identify analytes. In the described techniques which are also used to fabricate and manufacture sensors to detect analytes, an analyte is sensed by sensors that output electrical signals in response to the analyte. In one embodiment, a plurality of sensors is formed on a single integrated circuit and the described sensors may have diverse compositions.

Solid-state chemical sensors-based on arrays of polymer composite chemiresistors have been demonstrated by several other groups. In these references, the described chemical sensors are based on depercolation of insulating polymers blended with conducting material as an additive (typically carbon black). The polymer absorbs a vapor, swells and the resistance increases as the conducting component is separated (i.e. depercolation).

For further background reference, the following prior art documents are incorporated herein by reference in their entireties:
M. C. Lonergan, E. J. Severin, B. J. Doleman, S. A. Beaber, R. H. Grubbs, N. S. Lewis, Array-based vapor sensing using chemically sensitive carbon black-polymer resistors, Chem. Mater. 8 (1996) 2298-2312;
B. J. Doleman, R. D. Scanner, E. J. Severin, R. H. Grubbs, N. S. Lewis, Use of compatible polymer blends to fabricate arrays of carbon black-polymer composite vapor detectors, Anal. Chem. 70 (13) (1998) 2560-2564;
E. J. Severin, B. J. Doleman, N. S. Lewis, An investigation of the concentration dependence and response to analyte mixtures of carbon black/insulating organic polymer composite vapor detectors, Anal. Chem. 72 (2000) 658-688;
S. M. Briglin, M. S. Freund, P. Tokumaru, N. S. Lewis, Exploitation of spatiotemporal information and geometric optimization of signal/noise performance using arrays of carbon black-polymer composite vapor detectors, Sens. Actuators B 82 (2002) 54-74;
M. A. Ryan, A. V. Shevade, H. Zhou, M. L. Homer, Polymer-carbon black composite sensors in an electronic nose for air quality monitoring, MRS Bull. (2004) 714-719;
A. V. Shevade, M. A. Ryan, M. L. Homer, A. M. Manfreda, H. Zhou, K. S. Manatt, Sens. Actuators B 93 (2003) 84;
S. M. Briglin, N. S. Lewis, Characterization of the temporal response profile of carbon black-polymer composite detectors to volatile organic vapors, J. Phys. Chem. B 107 (2003) 11031;
J. Kameoka, D. Czaplewski, H. Liu, H. G. Craighead, Polymeric nanowire architecture, J. Mater. Chem. 14 (2004) 1503-1505;
H. Liu, J. Kameoka, D. A. Czaplewski, H. G. Craighead, Polymeric nanowire chemical sensor, Nano Lett. 4 (4) (2004) 671-675;
R. Kessick, G. Tepper, Microscale electrospinning of polymer nanofiber interconnections, Appl. Phys. Lett. 83 (3) (2003);
R. Kessick, J. Fenn, G. Tepper, The use of AC potentials in electrospinning/spraying processes, Polymer 45 (2004) 2981-2984;
N. Levit, G. Tepper, Supercritical CO2-assisted electrospinning, J. Supercrit. Fluids 31 (3) (2004) 329-333;
Y. Zhou, M. M. Freitag, J. Hone, C. Staii, A. T. Johnson Jr., N. J. Pinto, A. G. MacDairmid, Fabrication and electrical characterization of polyaniline based nanofibers with diameter below 30 nm, Appl. Phys. Lett. 84 (18) (2003);
N. J. Pinto, A. T. Johnson Jr., A. G. MacDiarmid, C. H. Mueller, N. Theofylaktos, D. C. Robinson, F. A. Niranda, Electrospun polyaniline/polyethylene oxide nanofiber field-effect transistor, Appl. Phys. Lett. 83 (20) (2004);
J. M. Deitzel, J. Kleinmeyer, D. Harris, N. C. Beck Tan, The effect of processing variables on the morphology of electrospun nanofibers and textiles, Polymer 4 (2001) 2261-2272;
D. H. Reneker, A. L. Yarin, H. Fong, S. Koombhongse, Bending instability of electrically charged liquid jets of polymer solutions in electrospinning, J. Appl. Phys. 87 (9) (2000) 4531-4547;
Y. M. Shin, M. M. Hohman, M. P. Brenner, G. C. Rutledge, Experimental characterization of electrospinning: the electrically forced jet and instabilities, Polymer 42 (2001) 9955-9967; and
B. Sundaray, V. Subramanian, T. S. Natarajan, R. Z. Xiang, C. C. Chang, W. S. Fann, Electrospinning of continuous aligned polymer fibers, Appl. Phys. Lett. 84 (7) (2004) 1222-1224.

### SUMMARY

Embodiments of the claimed subject matter provide apparatuses, methods and systems for detecting and/or identifying analytes. The embodiments include a four-component chemiresistive microsensor array based on electrospun polymer fiber composites can distinguish between each of the test vapors-based on the response pattern from the four-component array. The sensor array was exposed to four test vapors including two organic solvents, one alcohol and one chemical warfare agent stimulant. The sensor output was linear and reversible and the response time was typically less than 60 seconds. The sensor was able to distinguish between each of the test vapors-based on the response pattern from the four-component array.

One embodiment includes a solid-state chemical sensor microchip based on arrays of organic, polymer composite fibers directly interfaced with a microelectrode. The electrical resistance of the composite organic fibers is highly sensitive to the presence of chemical vapors and the resistance pattern, unique for each vapor, is used for species identification and quantification. Due to the very high surface to volume ratio, low thermal mass and linear geometry of the fibers, the sensor exhibits an extremely high sensitivity and rapid response. The array based sensing strategy is analogous to the mammalian sense of olfaction, which currently surpasses the performance of all existing man-made chemical sensors.

When a four-component microsensor array was exposed to trace levels (200 ppb) of 2,4 dinitrotoluene (DNT) vapor, the sensor exhibited very high sensitivity with an estimated detection limit of approximately 5 ppb and a response time of less than 1 minute. The array response pattern was unique and the DNT vapor could be distinguished from common background vapors such as organic solvents, alcohol and chlorinated organics.

The embodiments also include a solid-state chemical microsensor which can be used for HE detection. Laboratory testing has shown that this sensor has extremely high (approximately a few parts per billion) sensitivity to DNT vapor as well as a fast response, for example less than one minute. Because of this, and the fact that the array response pattern is unique, the DNT vapor can be discriminated from common background chemicals.

One embodiment includes a microchip based sensor for detecting at least one analyte which includes at least one microelectrode for measuring the electrical resistance of the at least one analyte, and an array of electrospun composite fibers interfaced with at least one of the microelectrodes. The one or more analytes are identified from the resistance pattern of the one or more analytes. Other embodiments can be used to identify and/or quantify one or more of the analytes from the resistance pattern of those one or more analytes.

Other embodiments can use one or more of the following polymers for the array: Polyethyleneoxide (PEO), Polyepichlorohydrin (PECH), Polyisobutylene (PIB), and Poly n-vinylpyrrolidone (PVP). Embodiments may use arrays having a large number of electrospun composite fibers that may vary from application to application.

Another embodiment includes a method of detecting one or more analytes using a solid state sensor microchip comprising the steps of initializing the sensor which is comprised of an array of electrospun polymer fibers interfaced with at least one microelectrode, presenting one or more analytes to the sensor, processing the resulting resistance pattern, and using the resistance pattern of the one or more analytes to detect, identify and/or quantify the one or more analytes.

### BRIEF DESCRIPTION OF THE DRAWINGS

FIG. 1 is a photograph and optical microscope image of an exemplary chemical microsensor apparatus.

FIG. 2 shows the structure of a Dinitrotoluene (DNT) molecule.

FIG. 3 is a plot of sensor response (change in resistance versus time) for the PECH sensor element exposed to 200 ppb of DNT.

FIG. 4 is an illustration of a sensor array response pattern to five different test vapors with the DNT pattern shown on the far right side.

FIG. 5 is a schematic diagram illustrating the electrospinning apparatus used to deposit fibers onto the microelectrode.

FIG. 6 is a series of light microscope images of the PEO, PIB, PECH and PVP composite fiber arrays on the surface of the interdigitated microelectrodes.

FIG. 7 is a plot of the normalized raw sensor output versus time for the four sensor elements exposed periodic cycles of toluene vapor at increasing concentrations.

FIG. 8 shows the response time of each sensor element as measured in response to each test vapor at one particular concentration.

FIG. 9 is a group of plots showing the sensor response magnitude (i.e. change in resistance divided by baseline resistance) as a function of vapor concentration was measured for each test vapor.

### DETAILED DESCRIPTION OF THE EMBODIMENTS

Embodiments of the claimed subject matter are directed to chemical sensors, systems and methods which use one or more arrays of organic, polymer composite fibers directly interfaced with a microelectrode. This particular class of chemical sensor has several unique and attractive features including a very simple construction, low power, high vapor sensitivity and the potential to be adapted for a wide range of applications including but not limited to defense and security, food inspection, industrial and environmental monitoring and medical diagnostics.

In several embodiments, each element of the array consists of a different non-specific, cross-selective polymer containing a dispersion of a conducting material such as carbon black. The composite material is normally deposited from solution in the form of a thin film between a pair of electrodes separated by a distance on the order of 1 mm. The electrodes are used to measure the electrical resistance of the composite film during vapor exposure. Vapors absorbed by a given array element produce a volumetric expansion in the polymer component and a resulting increase in the resistance of the composite due to a loss of conduction pathways—the depercolation effect. If the polymer component of each element of the array is appropriately selected to provide cross-selective sensitivity to a number of different chemicals or classes of chemicals, the pattern of resistance changes for each vapor can be unique and the array can be trained for the detection and identification of a wide range of chemical vapors. This approach to chemical sensing is often referred to as an electronic nose because it is analogous to the mammalian sense of olfaction. However, unlike the dense, microscopic olfactory receptors found in biological systems, the synthetic chemiresistor sensor elements developed to date are relatively large and the polymer composite films deposited by solvent casting have proven difficult to interface with microelectronic transducers. Recent results have suggested the possibility of developing fully-integrated chemiresistor microchips-based on electrospun polymer fibers. Unlike a two-dimensional film with many parallel conduction pathways, the electrical resistance of a one-dimensional wire will increase as soon as the first section of the wire undergoes depercolation. In addition, hundreds or even thousands of tiny electrospun fibers can be integrated onto a single microelectrode to provide a biomimetic architecture for chemical sensing.

One embodiment includes a solid-state chemical sensor microchip based on arrays of organic, polymer composite fibers directly interfaced with a microelectrode. The electrical resistance of the composite organic fibers is highly sensitive to the presence of chemical vapors and the resistance pattern, unique for each vapor, is used for species identification and quantification. Due to the very high surface to volume ratio, low thermal mass and linear geometry of the fibers, the sensor exhibits an extremely high sensitivity and rapid response. The array based sensing strategy is analogous to the mammalian sense of olfaction, which currently surpasses the performance of all existing man-made chemical sensors.

A four-component microsensor array was exposed to trace levels (200 ppb) of 2,4 dinitrotoluene (DNT) vapor. The sensor exhibited very high sensitivity with an estimated detection limit of approximately 5 ppb, and a response time of less than 1 minute. The array response pattern was unique and the DNT vapor could be distinguished from common background vapors such as organic solvents, alcohol and chlorinated organics.

The molecular structure for DNT is shown in FIG. 2. DNT is a solid at room temperature and has a very low vapor pressure. Therefore, sensors with extremely high vapor sensitivity are required for HE detection. The sensor array embodiment consisted of four microelectrodes, each based on one of the following four polymers: Polyethyleneoxide (PEO), Polyepichlorohydrin (PECH), Polyisobutylene (PIB), Poly n-vinylpyrrolidone (PVP). The sensor array was exposed to 200 ppb DNT vapor using a custom-built sensor calibration system.

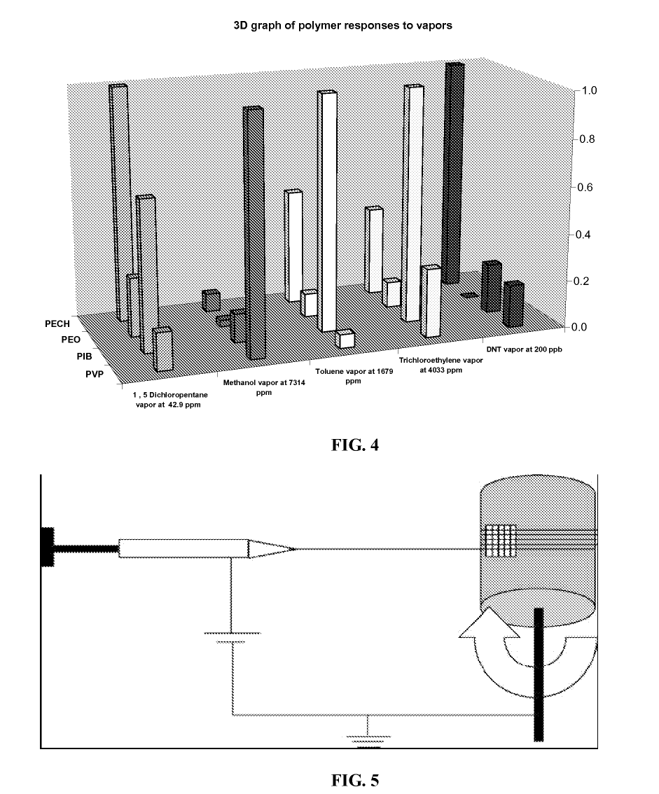

FIG. 4 is an illustration of a sensor array response pattern to five different test vapors with the DNT pattern shown on the far right side. Specifically, the results show the responses of a four-component sensor array to the following five different vapors: dichloropentane, methanol, toluene, dichloroethylene (TCE) and dinitrotoluene (DNT). The indicated response pattern for DNT is unique, and therefore, the DNT vapor can be discriminated from other organic and even aromatic compounds in the atmosphere.

The embodiments include a new solid-state chemical microsensor which can be used for HE detection. Laboratory testing has shown that this sensor has extremely high (approximately a few parts per billion) sensitivity to DNT vapor as well as a fast response, for example less than one minute. Because of this, and the fact that the array response pattern is unique, the DNT vapor can be discriminated from common background chemicals.

FIG. 5 is a schematic diagram illustrating the electrospinning apparatus used to deposit fibers onto the microelectrode. In one experiment, electrospun polymer composite fibers were deposited in the form of aligned arrays onto interdigitated microelectrodes. The fibers consist of an insulating polymer blended with carbon black near the percolation threshold and, therefore, the fiber resistance increases when the polymer component swells during vapor absorption. Microsensors were fabricated from four different cross-selective polymers and the electrical resistance of each element of the four-component sensor array was tested upon exposure to toluene, trichloroethylene, methanol and dichloropentane vapor. The sensitivity and response kinetics of each sensor element was measured for each vapor. The sensor elements exhibited a linear response as a function of vapor concentration and the response time ranged from several seconds to over 1 min. The four organic compounds could be discriminated-based on the unique response pattern from the sensor array.

An embodiment used is an electronic nose-based on a four-component array of chemically responsive, electrically conducting polymer fiber composites. The polymer composite fibers were produced using electrospinning, wherein polymer fibers are drawn from a solution using electric as opposed to mechanical forces. The principle advantage of the electrospinning fiber formation method is that very small fiber diameters, often less than 100 nm, can be achieved. Microscale fibers from four different polymer-carbon black suspensions were electrospun directly onto the surface of microelectrodes consisting of interdigitated gold strips deposited onto a glass substrate. The fibers consisted of a polymer-carbon black composite near the percolation threshold. The resulting sensor array was tested upon exposure to four different analyte vapors including one alcohol, two organic solvents and one chemical warfare agent stimulant. The vapor sensitivity and response kinetics for each sensor element was individually measured for the four test vapors. The response pattern from the four-component array was measured and was distinct for each test vapor.

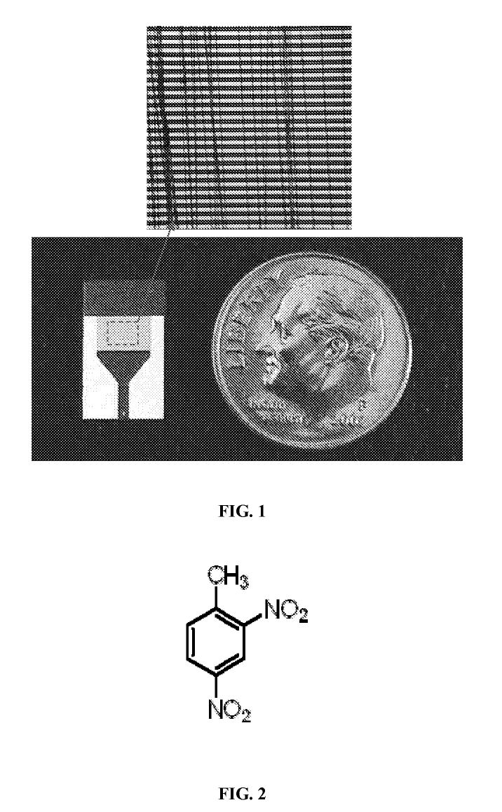

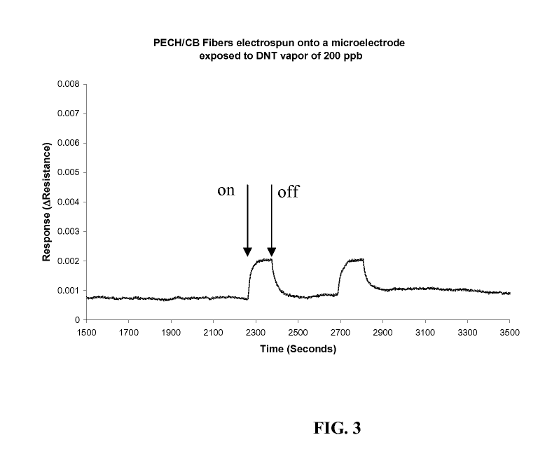

In an experiment, Poly(epichlorohydrin) (PECH), with a M_{w} of 700,000, poly(ethylene oxide) (PEO) with a M_{w} of 400,000 Da, poly(isobutylene) (PIB) with a M_{w} of 500,000 Da and poly(vinylpyrrolidone) (PVP) with a M_{w} of 1.3 million were purchased from Aldrich and the carbon black (Black Pearls 2000) was purchased from Cabot labs. For the PEO and PVP the electrospinning solution was an 8.0% w/w of polymer in DI water. A 9 wt. % solution of PIB was dissolved in toluene and the PECH was dissolved in chloroform at 9 wt. %. For all polymer formulations carbon black was added to provide a dry solids ratio of 80/15 of polymer/CB by weight. The electrospinning configuration was a 30 gauge blunt needle fit into a 1 ml plastic or glass syringe charged to between 5 and 7 kV DC (+) at the tip, with the target 2-3 cm away. For electrospinning the PEO and PVP solutions a plastic syringe was used while a glass syringe was used for the PIB and PECH solutions. Also, the PECH solution is solid at room temperature so it was necessary to liquefy the solution by heating to approximately 50° C. before use. The microelectrode substrates consisted of an interdigitated array of 15 nm wide gold electrodes deposited onto glass and were attached to a grounded counter electrode consisting of a hexagonal rotating drum (1725 rpm). The electrospun fibers were wound around the rotating drum and collected on the microelectrode as illustrated in FIG. 1. The flow rate of the polymer composite solution was approximately 4 μl/min and was controlled by a Harvard Apparatus PUD 2000 Infusion syringe pump.

The sensor elements were placed in a chamber for vapor exposure and the electrical resistance of each sensor element was determined by measuring the device current at constant voltage. Nitrogen was used both as a carrier gas and dilutant. The carrier stream was passed through a U-tube bubbler containing the analyte. A cooling bath was used to control the vapor pressure of the analyte and was typically 10.0° C. in the experiment described herein. The nitrogen/analyte gas stream was mixed with a pure nitrogen stream in order to control the analyte concentration. The current through the sensor element was monitored as a function of time during exposure to the analyte. During the testing the sensor element was at ambient temperature. Optical imaging of the sensor element was performed using a Canon Elura 50 Digital Camera mounted onto an Olympus® light microscope, and the camera was interfaced to a PC to capture the images. FIG. 1 is a photograph of the sensor chip in comparison to a dime and includes a microscope image of the sensor surface.

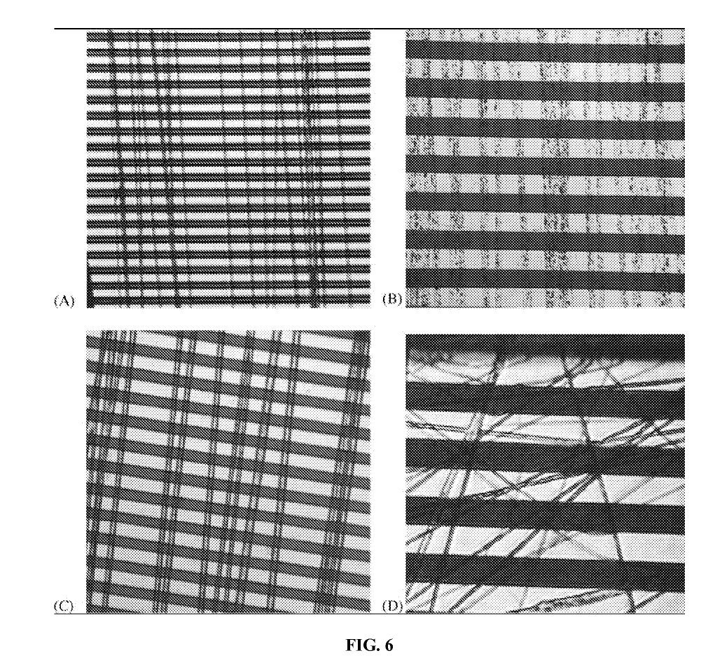

FIG. 6 is a series of light microscope images of the PEO, PIB, PECH and PVP composite fiber arrays on the surface of the interdigitated microelectrodes. The optical microscope images of the sensor element consisting of: (A) PECH; (B) PEO; (C) PIB; (D) PVP composite fibers on the surface of the interdigitated microelectrodes with an electrode spacing of approximately 15 μm.

The fibers range in diameter from about 1 to 5 μm for the images of FIG. 6 and it has been shown that the fiber diameter for each polymer composite depends strongly on the concentration of the polymer in the electrospinning solution. This information is consistent with the trends reported in previous experiments on electrospinning. There are also relationships between the fiber diameters and the performance of the sensors. The sensor response time, determined by Fickian diffusion of the vapor into the polymer, is known to improve as the size of the sensor element decreases and the electrospinning process is capable of producing fibers with extremely small diameters in the range of 50 nm. By carefully controlling the electrospinning conditions, aligned arrays of PECH, PEO and PIB fiber composites were produced and aligned in a direction running perpendicular to the gold electrodes. A high degree of fiber alignment in electrospinning is somewhat unusual, because the charged fibers are inherently unstable and normally oscillate violently resulting in a non-woven mat of fibers with random orientations. Recently, however, it has been demonstrated that, by controlling specific processing conditions, it is possible to produce aligned arrays of fibers using electrospinning. The PVP fibers illustrated in FIG. 6 are randomly oriented as is more typical of electrospun fibers and we are continuing to work with this system in order to improve the fiber alignment in the PVP sensor element.

In all four sensor elements, the coverage of the electrospun fibers (as depicted in FIG. 6) is uniform across the entire microelectrode surface. The net electrical resistance of the sensor element depends upon the individual fiber resistance and fiber density (the number of fibers per unit surface area) and ranged from 10 to 100Ω for the four devices described in the present embodiments. Because the fibers are deposited across an interdigitated electrode, the net electrical resistance of a sensor element is actually the sum of individual parallel fibers. Optical microscopy was used to estimate the number of individual fibers on each sensor electrode in order to calculate the electrical resistance of a single fiber. For all four composite fibers studied, the electrical resistance of the individual fibers ranged between 10⁵ and 10⁶Ω. Assuming that the fiber length is equal to the interdigitated electrode spacing (15 μm) and using a typical fiber diameter of 3 μm, the electrical resistivity of the electrospun composite fibers can be estimated and would fall in the range of 10⁻¹ to 10⁻² Ωm, which is similar to that of a semiconducting material such as elemental Germanium.

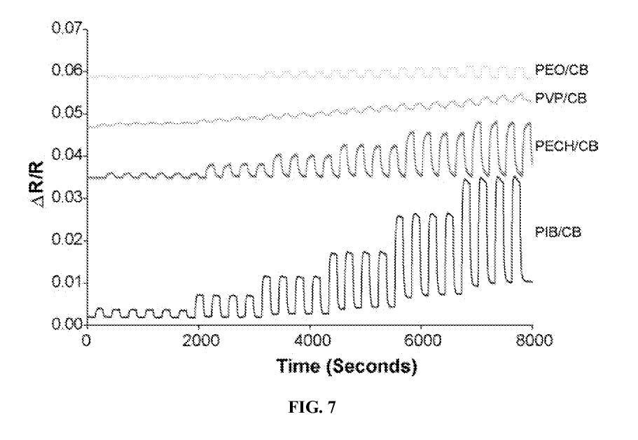

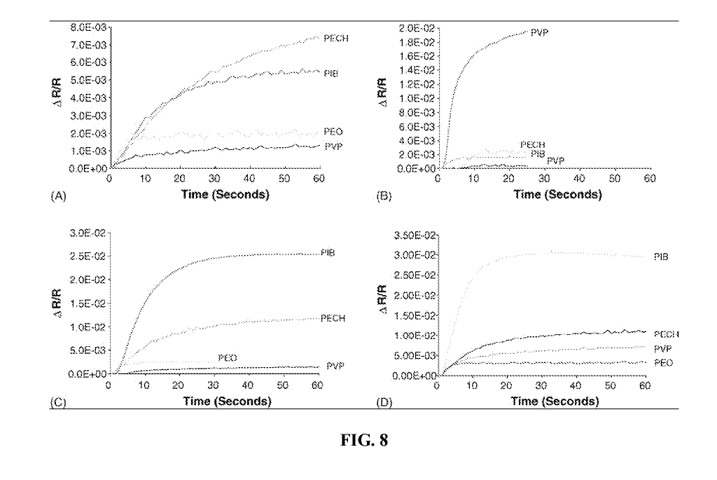

FIG. 7 is a plot of the normalized raw sensor output versus time for the four sensor elements exposed periodic cycles of toluene vapor at increasing concentrations. FIG. 7 illustrates the normalized sensor output (ΔR/R) as a function of time for each sensor element exposed to toluene vapor at several different and increasing concentrations. The baseline for each data set was shifted to allow superposition without overlap.

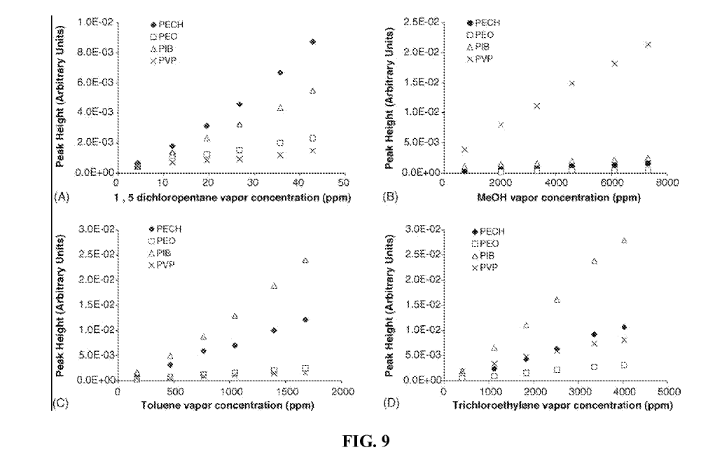

The toluene vapor was cycled on and off several times at each concentration with a duty cycle of 300 s (150 seconds on, 150 seconds off). For visual clarity the results for the PIB, PECH and PVP sensor elements were shifted down such that the data did not overlap. Similar data was obtained for the three other analytes. FIG. 8. shows the sensor output (ΔR/R) vs. time for each sensor element exposed to four different analyte vapors: (A) 1,5-dichloropentane; (B) methanol; (C) toluene; and (D) trichloroethylene. In general, the response time will depend on both the fiber diameter as well as the vapor permeation rate of through the polymer composite.

The sensor response kinetics can be derived as a function of fiber diameter and testing conditions. Specific values for other embodiments may be derived from carrying out the experiments similar to the previously described experiments. In the present embodiments, as shown in FIG. 8, the data presented, with the exception of the dichloropentane response, shows that the response time (time to reach 90% of the steady state value) was less than 60 seconds for each sensor element.

The sensor response magnitude (i.e. change in resistance divided by baseline resistance) as a function of vapor concentration was measured for each test vapor and is illustrated in FIG. 9. The output response for each sensor element was linear with concentration indicating the absence of saturation effects. The sensitivity of a given sensor element to a particular vapor depends on the chemical affinity of the polymer to the vapor and is determined from the slope of the response curve of FIG. 9. In use, the four polymers which were tested demonstrated sufficient cross-selectivity to identify each of the test vapors using the array response pattern.

As previously mentioned, FIG. 4 is a three-dimensional graph of the sensor array response pattern to each of the four analyte vapors. While the array response patterns are similar for the two solvents (toluene and TCE), the relative response magnitudes of the PVP and PEO sensor elements are reversed for these two analytes allowing discrimination. The array response patterns for the methanol and dichloropentane analytes were distinct from each other and from the toluene and TCE patterns.

The foregoing description of the multiple embodiments of the claimed subject matter have been presented for the purposes of illustration and description. The embodiments are not intended to be exhaustive or to limit the claimed subject matter to the disclosed embodiments, and many modifications and variations are possible in light of the teaching above. The embodiments were chosen and described in order to best explain the principles of the claimed subject matter and its practical applications to thereby enable others skilled in the art to best utilize and practice the claimed subject matter. It is intended that the scope of the claimed subject matter be defined solely by the following claims.

1. A microchip based sensor for detecting at least one analyte comprising:
at least one microelectrode for measuring the electrical resistance of the at least one analyte; and
an array of electrospun composite fibers interfaced with at least one of said micro electrodes;
wherein one or more analytes are identified from the resistance pattern of said one or more analytes.

2. The sensor of claim 1 wherein the at least one analyte is identified from the resistance pattern of said one or more analytes.

3. The sensor of claim 1 wherein the at least one analyte is quantified from the resistance pattern of said one or more analytes.

4. The sensor of claim 1 wherein said microelectrodes are based on polymers selected from the following group: Polyethyleneoxide (PEO), Polyepichlorohydrin (PECH), Polyisobutylene (PIB), and Poly n-vinylpyrrolidone (PVP).

5. The sensor of claim 1 wherein said array consists of two to ninety nine electrospun composite fibers.

6. The sensor of claim 1 wherein said array consists of one hundred to one thousand electrospun composite fibers.

7. The sensor of claim 1 wherein said array consists of one thousand to ten thousand electrospun composite fibers.

8. The sensor of claim 1 wherein said array consists of one thousand to ten thousand electrospun composite fibers.

9. The sensor of claim 1 wherein said array consists of ten thousand to ten million electrospun composite fibers.

10. A method of detecting one or more analytes using a solid state sensor microchip comprising the steps of:
initializing said sensor comprising an array of electrospun polymer fibers interfaced with at least one microelectrode;
presenting one or more analytes to said sensor;
processing the resulting resistance pattern; and
using the resistance pattern of said one or more analytes to detect said one or more analytes.

11. The method of detecting one or more analytes of claim 10 wherein the at least one analyte is identified from the resistance pattern of said one or more analytes.

12. The method of detecting one or more analytes of claim 10 wherein the at least one analyte is quantified from the resistance pattern of said one or more analytes.

13. The method of detecting one or more analytes of claim 10 wherein said microelectrodes are based on polymers selected from the following group: Polyethyleneoxide (PEO), Polyepichlorohydrin (PECH), Polyisobutylene (PIB), and Poly n-vinylpyrrolidone (PVP).

14. The method of detecting one or more analytes of claim 10 wherein said array consists of two to ninety nine electrospun composite fibers.

15. The method of detecting one or more analytes of claim 10 wherein said array consists of one hundred to one thousand electrospun composite fibers.

16. The method of detecting one or more analytes of claim 10 wherein said array consists of one thousand to ten thousand electrospun composite fibers.

17. The method of detecting one or more analytes of claim 10 wherein said array consists of one thousand to ten thousand electrospun composite fibers.

18. The method of detecting one or more analytes of claim 10 wherein said array consists of ten thousand to ten million electrospun composite fibers.

19. A system for detecting one or more analytes using a microchip based sensor comprised of at least one microelectrode for measuring the electrical resistance of the at least one analyte and an array of electrospun composite fibers interfaced with at least one of said microelectrodes, comprising:
presenting one or more analytes to said sensor; and
processing the resulting resistance pattern; and
using the one or more resistance patterns of said one or more analytes to detect said one or more analytes.

20. The system of claim 19 wherein one or more resistance patterns of said one or more analytes are further used to identify or quantify said one or more analytes.
